(19) United States
(12) Patent Application Publication
(10) Pub. No.: US 2001/0028496 A1
(43) Pub. Date: Oct. 11, 2001

(54) Method for aligning the optical beam path of a microscope, and microscope assemblage

(76) Inventor: Johann Engelhardt, Bad Schoenborn (DE)

Correspondence Address: Simpson, Simpson & Snyder, L.L.P., 5555 Main Street, Williamsville, NY, 14221, US

(21) Appl. No.: 09/817,646

(22) Filed: Mar. 26, 2001

(30) Foreign Application Priority Data
Mar. 29, 2000 (DE) 100 15 449.2

(51) Int. Cl. G02B 21/00; G02B 21/06

(52) U.S. Cl. 359/368; 359/383; 359/385

(57) ABSTRACT

A method for aligning the optical beam path of a microscope, in particular of a confocal microscope having a light source (1), a microscope optical system, a detection stop (12), and a detection device (13), is configured, in the interest of simplified alignment with reduced service and maintenance costs, in such a way that the detection stop (12) is used as the optical reference. Also provided is a microscope assemblage, having a light source (1), a microscope optical system, a detection stop (12), and a detection device (13), in which the detection stop (12) is usable as the optical reference.

### CROSS REFERENCE TO RELATED APPLICATIONS

This application claims priority of a German patent application DE 100 15 4491 filed Mar. 29, 2000 which is incorporated by reference herein.

### FIELD OF THE INVENTION

The invention concerns a method for aligning the optical beam path of a microscope, in particular of a confocal microscope having a light source, a microscope optical system, a detection stop, and a detection device.

The present invention further concerns a microscope assemblage, in particular a confocal microscope, having a light source, a microscope optical system, a detection stop, and a detection device.

### BACKGROUND OF THE INVENTION

Methods for aligning the optical beam path of a microscope, and corresponding microscope assemblages, are known from practical use and exist in a wide variety of embodiments. Methods and microscope assemblages of this kind are used, for example, in confocal microscopy. In confocal microscopy, a specimen is scanned with a focused light beam that is generated by a light source. A confocal scanning microscope generally also comprises a beam splitter, a scanning apparatus for beam control, a microscope optical system, a detection stop, and a detection device having detectors to detect the detected light and fluorescent light. If it is desired to observed several spectrally different fluorescences that were excited, for example, with a multiple-line laser, it is then often necessary to spread the detected light beam spectrally after passing through the detection stop, and use several detectors that must correspondingly be aligned with the spread-out partial light beams.

As with every optical alignment operation, reference locations to which all the alignment operations refer must be defined. For that purpose, an illumination stop is usually used as the “optical ground.” All downstream elements as well as the light source must then be aligned relative to this immovably mounted element.

The illumination stop is located almost at the beginning of the entire beam path. The optical elements that are arranged in its immediate vicinity—for example the light source or sources—can be aligned with reference to the optical axis defined by the stop more easily than, for example, the detectors, which are located at the end of the beam path. The explanation of this is that the alignment of the detectors is affected by the alignment of all the components located between the illumination stop and the detectors. It is necessary, so to speak, to rely on the previously performed alignment of all the components located between the illumination stop and the detectors. In addition, adjusting several detectors with respect to several partial light beams, which are created from one light beam by spectral spreading and must be reflected in different spatial directions or must pass through complex filter arrangements, is in any event very difficult and laborious.

A further problem with the known method and the known microscope assemblage is the fact that with every realignment of an optical component, for example the beam splitter, all the downstream elements must also be realigned. This affects in particular the difficult-to-align detectors and spectral spreading arrangements, which consequently are constantly the subject of an alignment operation. This ultimately results in considerable service and maintenance costs.

### SUMMARY OF THE INVENTION

It is therefore the object of the present invention to describe a method of the kind cited initially for aligning the optical beam path of a microscope, and a corresponding microscope assemblage, according to which simplified alignment with reduced service and maintenance costs is achieved with physically simple means.

According to the present invention, the aforesaid object is achieved by a method comprising the steps of:

A) providing the detection stop as a first optical reference point; and

B) providing a second reference point wherein the entire beam path is defined at the two reference points or in two planes.

What has been recognized firstly according to the present invention is that the difficult-to-align detection elements can be aligned much more easily if the detection stop located in the immediate vicinity is taken as the reference. In particular, alignment of the detection elements of the detection device with respect to the optical axis defined by the detection stop is considerably more precise. In addition, the detection device is, so to speak, optically insulated from the other elements by the detection stop. The result of this is that as a rule, realignment is necessary only for the elements of the microscope and illumination system that are under a great deal more stress because of the necessary mechanical movements. In other words, because the detection stop is selected as the optical reference, the detection device is decoupled from many alignment operations.

The aforesaid object is additionally achieved by a microscope assemblage having a light source, a microscope optical system, a detection device, a detection stop defining a first optical reference point and a second reference point wherein that the entire beam path is defined at the two reference points or in two planes.

What is achieved altogether with the method and the microscope assemblage according to the present invention is simplified alignment with reduced service and maintenance costs, with physically simple means.

In a concrete embodiment, the light source could be a point light source. What is intended here in particular is an illuminated aperture stop (called the “illumination stop”).

In a further advantageous embodiment, the light source could be a laser resonator. The term “light source” can encompass any lamps, lasers, glass fiber ends, etc. In particular, a confocal laser scanning microscope is achievable therewith.

Also in simple fashion, the focus of the resonator light bundle of the laser resonator in the laser resonator can be used as the point light source. An intra-laser point light source is thereby implemented. A focus of this kind is present in every optically stable laser resonator, and can thus be used as a “virtual” point light source. The use of an illumination stop is thereby made superfluous. The laser resonator, as the element farthest away from the optical reference, is then easier to align than when an illumination stop is used as the reference.

As an alternative to an intra-laser focus, the point light source could be constituted by an extra-laser focus. The extra-laser focus is generated outside the laser by focusing the illuminating light with a lens or a hollow mirror.

In particularly advantageous fashion, the entire beam path could be defined at two reference points or in two planes. In this context, the reference points could be located in planes conjugated with one another. The planes could also be Fourier planes.

The result is not only to guarantee that the beam path passes through the reference points, but also to define unequivocally the beam path itself.

It has been found in practical use that the detection stop and the objective pupil are particularly suitable as fixed reference points. Once they have been aligned with sufficient accuracy, any realignment can be shifted out to constitute an alignment of the illumination system. All other optical elements can be aligned with respect to these reference points. Even after replacement of an internal microscope component, realignment can be performed in rapid and uncomplicated fashion with the references described. In this context, alignment of the detector elements of the detector device is simplified by the physical proximity to the detection stop as optical reference. These detector elements are “insulated” by the detector stop, in terms of misalignments of optical components, from the rest of the system. Realignment of the detector elements as a result of misalignment of other elements can be avoided.

The method for aligning the optical beam path could be an iterative alignment method. In this context, only alignment of the laser may be necessary. The method as a whole converges after a few cycles. Two alignment operations could be used, alternatively or in combination, for alignment.

On the one hand, the point light source could be displaced laterally for alignment. This results in a displacement of the focus on the detection stop. The plane in which the point light source lies could be a plane corresponding to the plane of the detection stop. By way of an X-Y displacement device, the point light source could be brought into alignment until the focus of the detected light precisely strikes the detection pinhole or detection stop.

When an illumination stop is used, the lateral displacement of the point light source could be accomplished by way of a lateral displacement of the illumination stop. When an intra-laser focus is used as the point light source, a lateral displacement of the laser is necessary for alignment. When an extra-laser focus is used, the illuminating light beam could be displaced by lateral displacement of the laser together with the focusing lens. In addition, with an extra-laser focus the illuminating light beam could be laterally displaced by rotating the laser about the pupil of the focusing lens. In other words, when an extra-laser focus is used as the point light source, a lateral displacement is made possible by rotation of the laser output light beam about the pupil of the lens that generates the point light-source focus.

In particularly simple fashion, the light output measured by the detection device behind the detection stop could be used as an optimization variable during alignment.

As a further alignment operation, on the other hand the illuminating light beam could be rotated or tilted about the location of the point light source. Such a rotation of the illuminating light beam path about the location of the point light source results in a beam displacement at the location of the entry pupil of the objective, since the pupil is located in a Fourier plane conjugated with the point light source. Concretely, the illuminating light beam could be rotated or tilted about an illumination stop that is provided. A rotation of this kind is possible by displacing the parallel laser output light beam perpendicular to the principal plane of the lens illuminating the pinhole. If the focus is used as the point light source, the laser must then be rotated about its internal focus in order to align the beam path with respect to the pupil of the microscope objective.

With an extra-laser focus, the illuminating light beam could be rotated about the focus by rotating the laser together with the focusing lens. Alternatively, as already mentioned, in the case of an extra-laser focus the illuminating light beam could be rotated about the focus by displacing the laser parallel to the principal plane of the focusing lens.

Overall, the extra-laser focus, which serves instead of an illumination stop as a “virtual” point light source, can be aligned with respect to the beam path.

Alignment of an intra-laser focus could be accomplished by three-dimensional alignment of the laser.

By way of an output measurement after the microscope objective, it is easy to verify whether the pupil is being centeredly illuminated.

In a particularly preferred alignment method, the lateral displacement of the point light source and the rotation or tilting of the illuminating light beam about the location of the point light source could be accomplished alternatingly.

Regarding the advantages of a microscope assemblage configured according to the present invention, reference is made, in order to avoid repetition, to the advantageous design embodiments described in the context of the method according to the present invention.

In particularly advantageous fashion, the detection device and the detection stop could be configured as a preferably replaceable complete module. When a device for spectral spreading of the light beam to be detected is provided, it would moreover be possible to configure the detection device, the device for spectral spreading of the light beam to be detected, and the detection stop as a preferably replaceable complete module.

All in all, the method and the microscope assemblage according to the present invention make available a method for improved alignment and an arrangement for more practical, more stable, and more easily realignable adjustment of the optical beam path of a preferably confocal microscope.

### BRIEF DESCRIPTION OF THE DRAWINGS

There are various ways of advantageously embodying and developing the teaching of the present invention. Reference is made, for that purpose, on the one hand to the subordinate claims, and on the other hand to the explanation below of the method according to the present invention with reference to the drawings. In conjunction with the explanation of the method according to the present invention with reference to the drawings, an explanation is also given of generally preferred embodiments and developments of the teaching. In the drawings:

FIG. 1 schematically depicts the state of optimum alignment of a microscope assemblage;

FIG. 2 schematically depicts the influence of a lateral displacement of the point light source, showing a tilting of the beam path about the objective pupil and a displacement of the beam path perpendicular to the plane of the detection pinhole;

FIG. 3 schematically depicts the influence of a rotation of the illuminating light beam about the location of the point light source, an illumination stop being used here as the point light source and a displacement of the beam path at the location of the objective pupil being evident;

FIG. 4 schematically depicts an embodiment of an alignable point light source in the context of extra-laser focus;

FIG. 5 shows a further embodiment of an alignable point light source in the context of extra-laser focus;

FIG. 6 shows an embodiment of an alignable point light source in the context of intra-laser focus; and

FIG. 7 shows a further embodiment of an alignable point light source in the context of intra-laser focus.

### DETAILED DESCRIPTION OF THE INVENTION

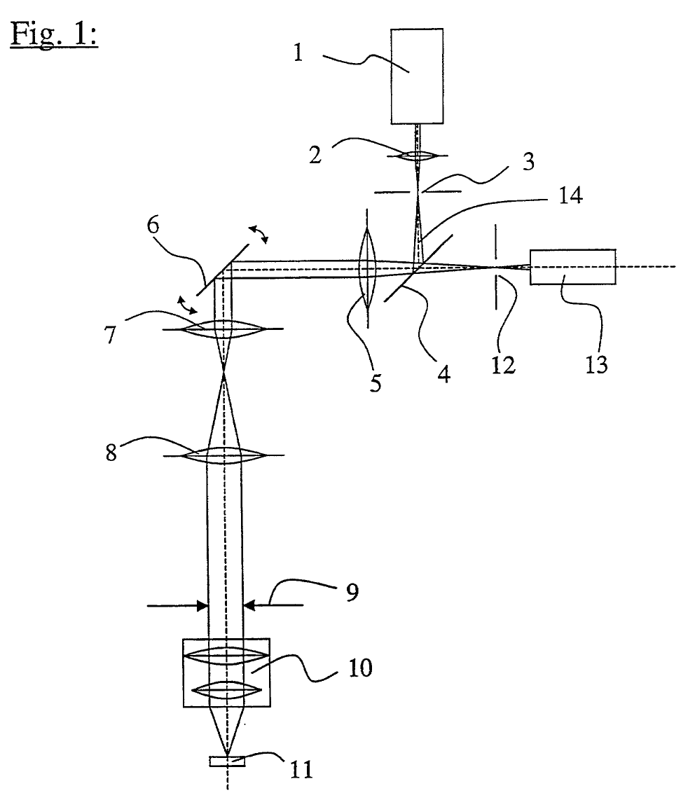

FIGS. 1 through 3 each show the beam path of a confocal microscope assemblage. The assemblage has a light source 1 which is a laser resonator. The illuminating light of light source 1 is focused by a lens 2 onto an illumination stop 3. A beam splitter 4 reflects the illuminating light onto a lens 5 and a scanning mirror 6. Scanning mirror 6 allows the light beam to be guided in the X-Y direction.

After scanning mirror 6, the beam path passes through two further lenses 7 and 8; pupil 9 of objective 10 is formed after lens 8. Arranged after objective 10 is a specimen 11 over which the illuminating beam is scanned by way of scanning mirror 6.

Light reflected from the specimen, and/or fluorescent light, is directed via beam splitter 4 onto a detection stop 12. Detection device 13, with a detector, is provided behind detection stop 12. In other words, illuminating light 14 generated by light source 1 is directed to specimen 11, back again to beam splitter 4, and then on to detection device 13.

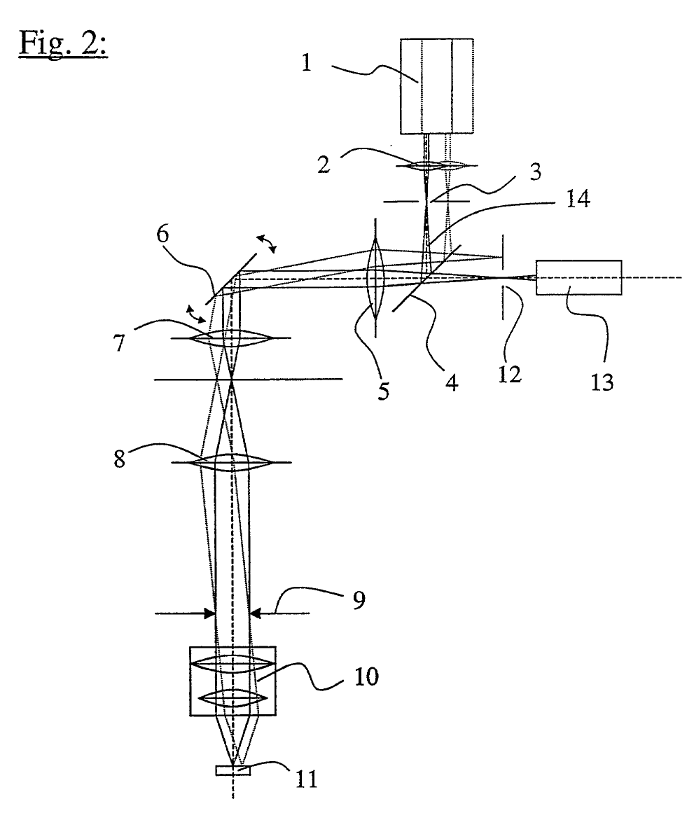

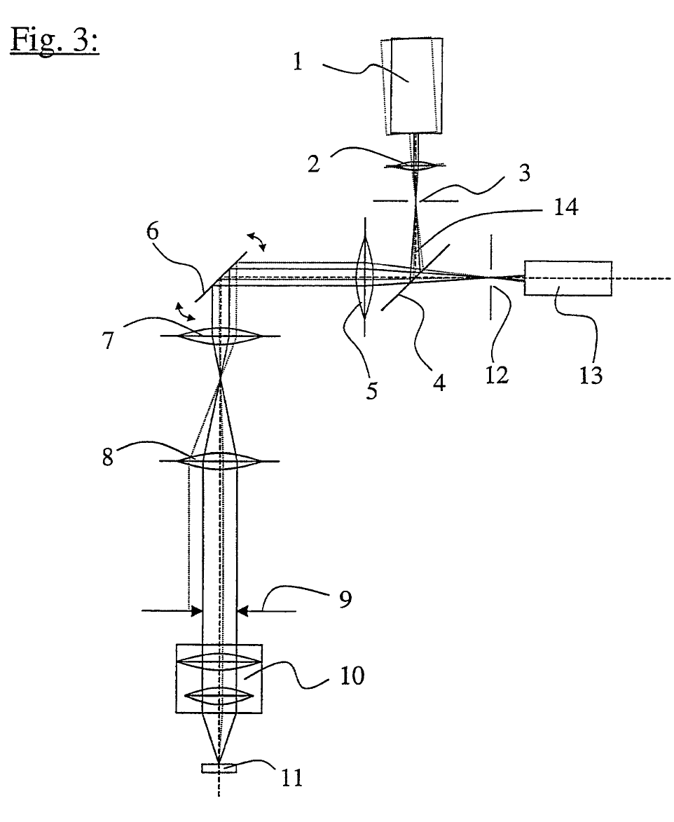

FIG. 1 shows the state of optimal alignment. FIG. 2 shows the influence of a lateral displacement of light source 1, showing a tilting of the beam path about objective pupil 9 and a displacement of the beam path perpendicular to the plane of detection stop 12. FIG. 3 shows the influence of a rotation of illuminating light beam 14 about the location of the point light source or illumination stop 3. A displacement of the beam path at the location of objective pupil 9 is apparent here.

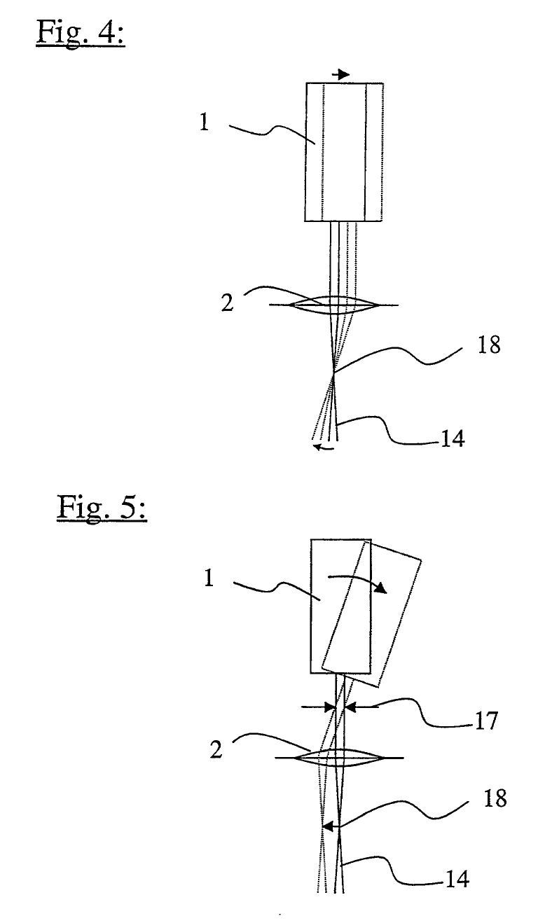

FIG. 4 shows an embodiment of an alignable light source 1 in the context of an extra-laser focus 18. Displacement of light source 1 parallel to the principal plane of the focusing lens 2 causes illuminating light beam 14 to be rotated about focus 18.

FIG. 5 shows a further embodiment of an alignable light source 1 in the context of an extra-laser focus 18. Here the pupil of lens 2 is designated 17. Rotation of light source 1 about pupil 17 of the focusing lens 2 causes illuminating light beam 14 to be laterally displaced.

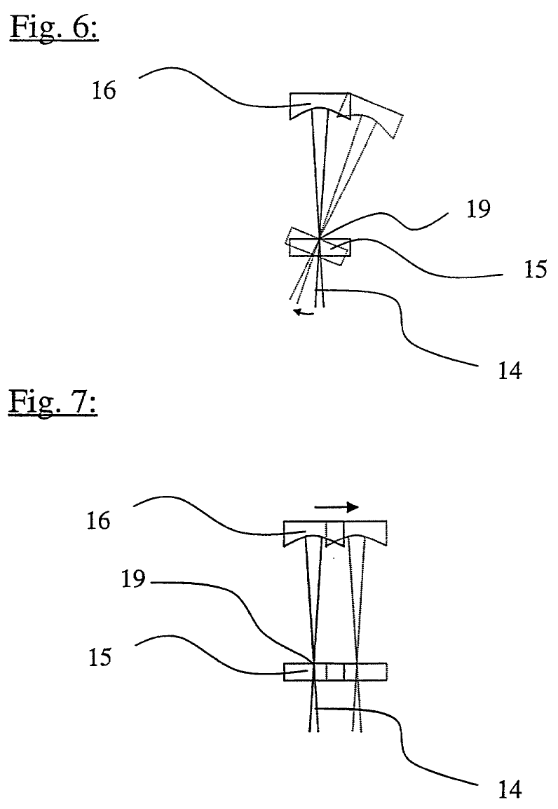

FIG. 6 shows an embodiment of an alignable point light source in the context of an intra-laser focus 19. The number 15 designates a plane laser resonator end mirror. The number 16 designates a curved laser resonator end mirror. FIG. 7 shows a further embodiment of an alignable point light source in the context of an intra-laser focus 19. In the case of intra-laser focus 19 in accordance with the exemplary embodiments shown in FIGS. 6 and 7, alignment of the illuminating light source is accomplished by three-dimensional alignment of the laser.

To eliminate repetition, reference is made to the general portion of the specification and to the appended claims regarding further advantageous embodiments of the method and the microscope assemblage according to the present invention.

Lastly, be it noted expressly that the exemplary embodiment discussed above of the method and the microscope assemblage according to the present invention serves merely for discussion of the teaching claimed, but does not limit it to the exemplary embodiment.

Parts List

1 Light source; laser

2 Lens

3 Illumination stop

4 Beam splitter

5 Lens

6 Scanning mirror

7 Lens

8 Lens

9 Pupil of the objective

10 Objective

11 Specimen

12 Detection stop

13 Detector; detection device

14 Illuminating light beam

15 Plane laser resonator end mirror

16 Curved laser resonator end mirror

17 Pupil of lens 2

18 Extra-laser illumination focus; point light source

19 Intra-laser illumination focus; point light source

What is claimed is:

1. A method for aligning the optical beam path of a microscope, having a light source (1), a microscope optical system, a detection stop (12), and a detection device (13), wherein the method comprises the steps of:
A) providing the detection stop (12) as a first optical reference point; and
B) providing a second reference point wherein the entire beam path is defined at the two reference points or in two planes.

2. The method as defined in claim 1, characterized in that the light source (1) is a point light source.

3. The method as defined in claim 1, characterized in that the reference points are located in planes conjugated with one another.

4. The method as defined in claim 1, characterized in that the planes are Fourier planes.

5. The method as defined in claim 1, characterized in that the second reference point is an objective pupil (9).

6. The method as defined in claim 1, characterized in that all optical elements are aligned with respect to the reference points or planes.

7. The method as defined in claim 1, characterized in that the method is an iterative alignment method.

8. The method as defined in claim 1, characterized in that the light source is displaced laterally for alignment.

9. The method as defined in claim 1, characterized in that the plane in which the light source lies is a plane corresponding to the plane of the detection stop (12).

10. The method as defined in claim 8, characterized in that the lateral displacement of the light source is accomplished by way of a lateral displacement of the illumination stop (3).

11. The method as defined in claim 1, characterized in that the microscope is a confocal microscope.

12. A microscope assemblage, having a light source (1), a microscope optical system, a detection device (13), a detection stop (12) defining a first optical reference point and a second reference point wherein that the entire beam path is defined at the two reference points or in two planes.

13. The microscope assemblage as defined in claim 12, characterized in that the light source (1) is a point light source.

14. The microscope assemblage as defined in claim 12, characterized in that the light source (1) is a laser resonator defining a resonator light bundle.

15. The microscope assemblage as defined in claim 14, characterized in that the focus of the resonator light bundle of the laser resonator in the laser resonator serves as the intra-laser point light source (19).

16. The microscope assemblage as defined in claim 13, characterized in that the point light source is constituted by an extra-laser focus (18).

17. The microscope assemblage as defined in claim 16, characterized in that the extra-laser focus (18) is generated by focusing the illuminating light with a lens (2) or a hollow mirror.

18. The microscope assemblage as defined in claim 12, characterized in that the reference points are located in planes conjugated with one another.

19. The microscope assemblage as defined in claim 18, characterized in that the planes are Fourier planes.

20. The microscope assemblage as defined in claim 12, characterized in that in addition to the detection stop (12), an objective pupil (9) serves as a reference point.

21. The microscope assemblage as defined in claim 12, characterized in that all optical elements are alignable with respect to the reference points or planes.

22. The microscope assemblage as defined in claim 13, characterized in that the point light source is displaceable laterally for alignment.

23. The microscope assemblage as defined in claim 22, characterized in that the lateral displacement of the point light source is accomplished by way of a lateral displacement of the illumination stop (3).

24. The microscope assemblage as defined in claim 16, characterized in that in the extra-laser focus (18) of the point light source defining the illuminating light beam is laterally displaced by lateral displacement of the laser together with a focusing lens.

25. The microscope assemblage as defined in claim 24, characterized in that the extra-laser focus (18) defining the illuminating light beam is laterally displaced by rotation of the laser about the pupil of the focusing lens.

26. The microscope assemblage as defined in claim 13, characterized in that for alignment, the illuminating light beam is rotated or tilted about the location of the point light source.

27. The microscope assemblage as defined in claim 26, characterized in that the illuminating light beam is rotated or tilted about the illumination stop (3).
